(19) United States
(12) Patent Application Publication
(10) Pub. No.: US 2022/0332162 A1
(43) Pub. Date: Oct. 20, 2022

(54) INTEGRATED THERMAL MANAGEMENT MODULE FOR VEHICLE

(71) Applicants: Hyundai Motor Company, Seoul (KR); Kia Corporation, Seoul (KR); Hyundai Wia Corporation, Changwon (KR)

(72) Inventors: Sang Shin Lee, Suwon (KR); Hyeon Keun Yun, Hwaseong (KR); Ki Mok Kim, Hwaseong (KR); Hyo Chan Bae, Hwaseong (KR); Man Ju Oh, Yongin (KR); Chang Won Lee, Suwon (KR); Hyun Jun Seo, Seoul (KR); Sang Min Lee, Hwaseong (KR); Je Min Yeon, Suwon (KR)

(21) Appl. No.: 17/532,696

(22) Filed: Nov. 22, 2021

(30) Foreign Application Priority Data
Apr. 19, 2021 (KR) 10-2021-0050473

(51) Int. Cl. B60H 1/00; B60H 1/32; B60K 11/04

(52) U.S. Cl. CPC B60H 1/00278; B60H 1/00392; B60H 1/3227; B60K 11/04; B60H 2001/00307

(57) ABSTRACT

An integrated thermal management module for a vehicle includes a multi-channel including a plurality of valve spaces and a plurality of coolant channels communicating with the valve spaces and disposed around the valve spaces, a plurality of valve bodies inserted into the valve spaces, respectively, and configured to open and close the coolant channels around the valve spaces of the multi-channel upon operation, and a plurality of pumps coupled to the multi-channel. The valve spaces are formed on one side of the multi-channel, the valve bodies are coupled to the one side of the multi-channel, the pumps are coupled to an opposite side of the multi-channel, and a rotation axis of each of the valve bodies and a rotation axis of each of the pumps are identical.

### CROSS REFERENCE TO RELATED APPLICATION

The present application claims under 35 U.S.C. § 119(a) the benefit of Korean Patent Application No. 10-2021-0050473 filed on Apr. 19, 2021, the entire contents of which are incorporated by reference herein.

### BACKGROUND

### (a) Technical Field

The present disclosure relates to an integrated thermal management module for a vehicle, which can effectively manage heat of a battery and electronics of the vehicle, i.e., an electric vehicle (EV), more particularly, to the integrated thermal management module in which a reservoir, a chiller, a pump, etc. are coupled around a multi-channel in which a valve space is formed.

### (b) Description of the Related Art

Recently, an electric vehicle has emerged as a preferred type of vehicle incorporating eco-friendly technology which may help address environmental issues including climate change. The electric vehicle operates using a motor that outputs electric power by using electricity received from a battery. Accordingly, the electric vehicle is viewed as eco-friendly vehicle in that there is no emission of carbon dioxide, very little noise, and where the motor is more energy efficient than an internal combustion engine.

In implementing such an electric vehicle, a core technology is that related to a battery module. Active research is being carried out with an objection of reducing the weight and size of the battery, a short charging time, etc. The battery module can maximize performance and achieve a long lifespan only when used in an optimal temperature environment. However, it is difficult to use the battery module in an optimal temperature environment due to heat occurring during driving and an external temperature change.

An integrated thermal management system has recently been constructed by integrating the cooling and heating systems of such a battery and an air-conditioning system for indoor air-conditioning of a vehicle.

In a conventional technology such as that disclosed in Korean Patent Application No. 10-2019-0019178, a valve, a chiller, a pump, etc. constituting a thermal management module are coupled around a reservoir. In order to satisfy stiffness, durability, stability, etc. necessary for the thermal management system, the reservoir has to be fabricated using a relatively heavy material that requires stiffness, such as a metal material.

An increase in weight of the reservoir directly leads to an increase in weight of the thermal management system, which results in an increase in weight of the vehicle. If the weight of the vehicle is increased, there is a problem in that battery efficiency is low because mileage of the vehicle is reduced compared to battery output. In general, a material having stiffness is opaque, and has a problem in that it is difficult to measure an amount of a coolant present within a reservoir. Furthermore, the thermal management system is constructed around the reservoir. Accordingly, there is a problem in that fluidity is low because it is difficult to easily change the structure of the thermal management system.

Accordingly, there is a need for a thermal management system having a reduced weight, improved visibility of a reservoir, and a flexible structure for a system configuration. The foregoing explained as the background is intended merely to aid in the understanding of the background of the present disclosure, and is not intended to mean that the present disclosure falls within the purview of the related art that is already known to those skilled in the art.

### SUMMARY

The present disclosure provides an integrated thermal management module in which a reservoir, a chiller, a pump, and a driving unit are coupled around a multi-channel into which a valve body is inserted and which has a reduced weight and improved visibility of the reservoir and can effectively manage heat of a battery and an electronic part. In particular, the present disclosure provides a compact design for an integrated thermal management module and to provide the most effective layout advantageous even for a molding structure by making identical a rotation axis of the pump and a rotation axis of the valve body.

An integrated thermal management module for a vehicle according to an embodiment of the present disclosure includes a multi-channel including a plurality of valve spaces and a plurality of coolant channels communicating with the valve spaces and disposed around the valve spaces, a plurality of valve bodies inserted into the valve spaces, respectively, and configured to open and close the coolant channels around the valve spaces of the multi-channel upon operation, and a plurality of pumps coupled to the multi-channel. The valve spaces are formed on one side of the multi-channel, the valve bodies are coupled to the one side of the multi-channel, the pumps are coupled to an opposite side of the multi-channel, and a rotation axis of the valve body and a rotation axis of the pump are identical.

The integrated thermal management module may further include a reservoir coupled to the multi-channel and configured to have an inside partitioned into a plurality of storage spaces and to have the storage spaces coupled to the coolant channels of the multi-channel, and a chiller coupled to the multi-channel and configured to have a coolant and a refrigerant thermally exchanged therein and to have a coolant flow channel therein partitioned into a plurality of spaces, wherein the space for each coolant flow channel is coupled to each valve space of the multi-channel through a coolant entrance.

A degassing space for degassing of a coolant may be provided on an upper side of the reservoir, and the degassing space may be coupled to a coolant exit of the chiller.

The chiller further may include a degassing pipe branched from a coolant entrance or exit of the chiller or a radiator inlet and configured to communicate with a degassing space of the reservoir.

The multi-channel and the reservoir may be made of different materials, and the reservoir may be made of a softer material than the multi-channel.

The reservoir may be disposed over the multi-channel, and a multi-channel coupling part for coupling the coolant channel of the multi-channel and the reservoir may be disposed at the bottom of each of the storage spaces.

A contact groove may be inward indented and formed at the end of the multi-channel coupling part. The coolant channel may be inserted and fitted into the contact groove so that an outer circumference surface and inner circumference surface of the coolant channel are surrounded and coupled to the end of the multi-channel coupling part.

A friction unit may be provided in the contact groove of the multi-channel coupling part into which the coolant channel is inserted.

A first fastening unit may be provided at the coolant entrance of the chiller, a third fastening unit may be provided on the one side of the multi-channel, and the chiller and the multi-channel may be coupled through the coupling of the first fastening unit and the third fastening unit. A second fastening unit may be provided on one side of the chiller, a fourth fastening unit may be provided on the outside of the reservoir, and the chiller and the reservoir may be coupled through the coupling of the second fastening unit and the fourth fastening unit.

The coolant entrance of the chiller may be integrated and molded with the chiller.

An integrated thermal management module for a vehicle according to an embodiment of the present disclosure includes a multi-channel including a plurality of valve spaces, and a plurality of coolant channels communicating with the valve spaces and disposed around the valve spaces, a reservoir coupled to the multi-channel and configured to have an inside partitioned into a plurality of storage spaces and to have the storage spaces coupled to coolant channels of the multi-channel, a plurality of pumps coupled to the multi-channel in a way to communicate with the valve spaces, respectively, and a plurality of valve bodies inserted into the valve spaces, respectively, and configured to open and close the coolant channels around the valve spaces of the multi-channel upon operation.

The integrated thermal management module may further include a chiller coupled to the multi-channel and configured to have a coolant and a refrigerant thermally exchanged therein and to have a coolant flow channel therein partitioned into a plurality of spaces, wherein the space for each coolant flow channel is coupled to each valve space of the multi-channel through a coolant entrance.

The chiller further may further include a degassing pipe branched from a coolant entrance or exit of the chiller or a radiator inlet and configured to communicate with a degassing space of the reservoir.

A degassing space for degassing of a coolant may be provided on an upper side of the reservoir, and the degassing space may be coupled to a coolant exit of the chiller.

The multi-channel and the reservoir may be made of different materials, and the reservoir may be made of a softer material than the multi-channel.

### BRIEF DESCRIPTION OF THE DRAWINGS

The above and other objects, features and other advantages of the present disclosure will be more clearly understood from the following detailed description when taken in conjunction with the accompanying drawings, in which:

FIG. 1 is a concept view of an integrated thermal management module for a vehicle according to an embodiment of the present disclosure.

FIG. 2 is an exploded perspective view of the integrated thermal management module for a vehicle according to an embodiment of the present disclosure.

FIG. 3 is a perspective view of the integrated thermal management module for a vehicle according to an embodiment of the present disclosure.

FIG. 4 illustrates a flow of a coolant within a chiller of the integrated thermal management module for a vehicle according to an embodiment of the present disclosure.

FIG. 5 is a circuit diagram of the integrated thermal management module according to an embodiment of the present disclosure.

FIGS. 6 and 7 are diagrams illustrating a flow of a coolant in the integrated thermal management module according to an embodiment of the present disclosure.

FIGS. 8 to 10 are circuit diagrams illustrating a flow of a coolant in the integrated thermal management module according to an embodiment of the present disclosure.

FIG. 11 illustrates that an internal reservoir of the integrated thermal management module for a vehicle according to an embodiment of the present disclosure has been simplified.

FIG. 12 illustrates the state in which the reservoir and a multi-channel according to an embodiment of the present disclosure are coupled.

FIG. 13 illustrates the state in which the reservoir and the multi-channel according to another embodiment of the present disclosure are coupled.

FIG. 14 illustrates the state in which the reservoir of a chiller and the multi-channel according to an embodiment of the present disclosure are coupled.

### DETAILED DESCRIPTION OF THE DISCLOSURE

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, embodiments of the present disclosure for achieving the aforementioned object and solving the aforementioned problem will be described in detail with reference to the accompanying drawings. Meanwhile, in understanding the present disclosure, specific descriptions of known techniques in the same field will be omitted when not helping to understand the core contents of the disclosure, and the technical spirit of the present disclosure is not limited thereto and may be variously modified and implemented by those skilled in the art.

Each of a reservoir 200 and a coolant flow channel 420 of a chiller 400, that is, some components of an integrated thermal management module for a vehicle according to an embodiment of the present disclosure, may be partitioned into n spaces depending on the number of parts mounted thereon.

If components necessary for cooling within a vehicle are an electronic part E and a battery B, each of the reservoir 200 and the coolant flow channel 420 of the chiller may be divided into two partitions. A coolant that cools the electronic part E and a coolant that cools the battery B may not be mixed in the reservoir 200 and the chiller 400. In this description, as an embodiment, an example is described in which components requiring cooling are the electronic part E and the battery B.

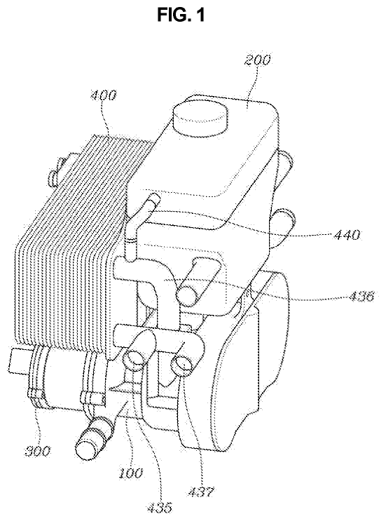

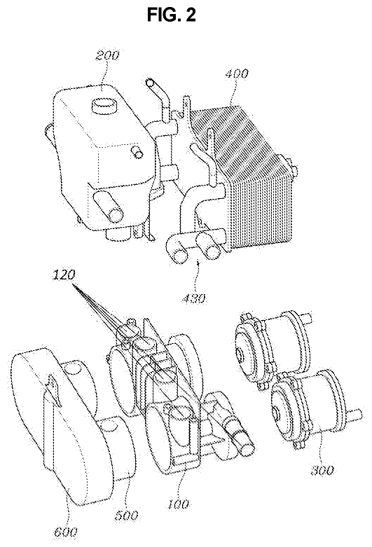

FIG. 1 is a concept view of an integrated thermal management module for a vehicle according to an embodiment of the present disclosure. FIG. 2 is an exploded perspective view of the integrated thermal management module for a vehicle according to an embodiment of the present disclosure. The integrated thermal management module for a vehicle according to an embodiment of the present disclosure includes a multi-channel 100 in which a plurality of valve spaces and a plurality of coolant channels 120 communicating with the valve spaces is disposed around the valve spaces, a valve body 500 (provided in plural, such that there are a plurality of valve bodies 500) inserted into each of the valve spaces, and configured to open and close the coolant channels 120 around the valve spaces of the multi-channel upon operation, and a pump 300 (provided in plural, such that there are a plurality of pumps 300) and coupled to the multi-channel. The valve spaces are formed on one side of the multi-channel. The valve bodies are coupled to the one side of the multi-channel. The pumps are coupled to an opposite side of the multi-channel. A rotation axis of the valve body and a rotation axis of the pump are identical.

Referring to FIG. 2, in the integrated thermal management module of the present disclosure, the valve bodies are coupled to the one side of the multi-channel, and the pumps are coupled to the opposite side of the multi-channel. In this case, there are advantages in that the integrated thermal management module can be compactly designed and can have the most effective layout advantageous for a molding structure because the rotation axes of the valve body and the pump are coupled to be identical.

Furthermore, the integrated thermal management module for a vehicle may further include the reservoir 200 coupled to the multi-channel 100 and configured to have the inside partitioned into a plurality of storage spaces and to have the storage spaces coupled to the coolant channels 120 of the multi-channel; and the chiller 400 coupled to the multi-channel 100 and configured to have a coolant and a refrigerant thermally exchanged therein and to have the coolant flow channel 420 therein partitioned into a plurality of spaces, wherein the space for each coolant flow channel is coupled to each valve space of the multi-channel through coolant entrance 430.

Specifically, the construction of the present disclosure is described. The valve space into which the valve body 500 is inserted is formed in plural number within the multi-channel 100. The plurality of coolant channels 120 communicating with the valve spaces is disposed around the valve spaces. Each valve body 500 is rotated in the valve space by a driving unit, such as an actuator 600, and controls a flow and direction of a coolant within the multi-channel. That is, the coolant channels 120 communicating with the valve spaces are opened or closed by the rotation of the valve bodies 500, so that a coolant may flow or not flow into the coolant channels 120.

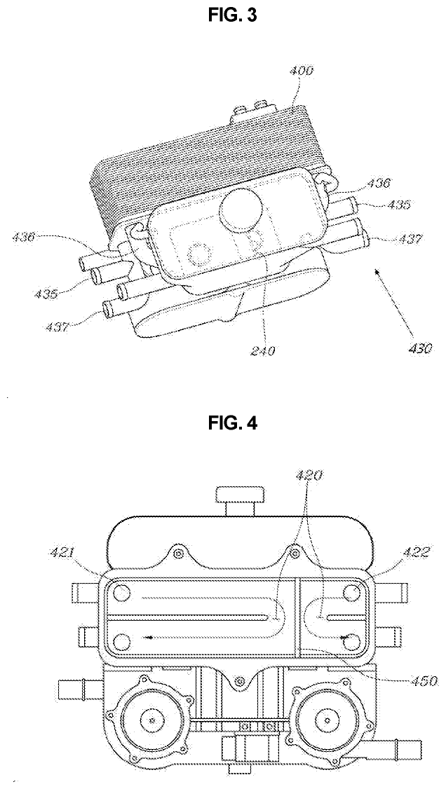

The reservoir 200 plays a role of storing a coolant. Referring to FIGS. 2 and 3, the reservoir 200 is coupled to the multi-channel 100. The reservoir 200 may be partitioned into the plurality of storage spaces by a barrier rib 240 formed therein. Accordingly, coolants in the storage spaces may be stored without being mixed together. Furthermore, since the storage spaces within the reservoir 200 are coupled to the coolant channels of the multi-channel, the reservoir 200 may supply a coolant to the multi-channel 100 in response to a movement of the valve bodies 500 within the multi-channel 100.

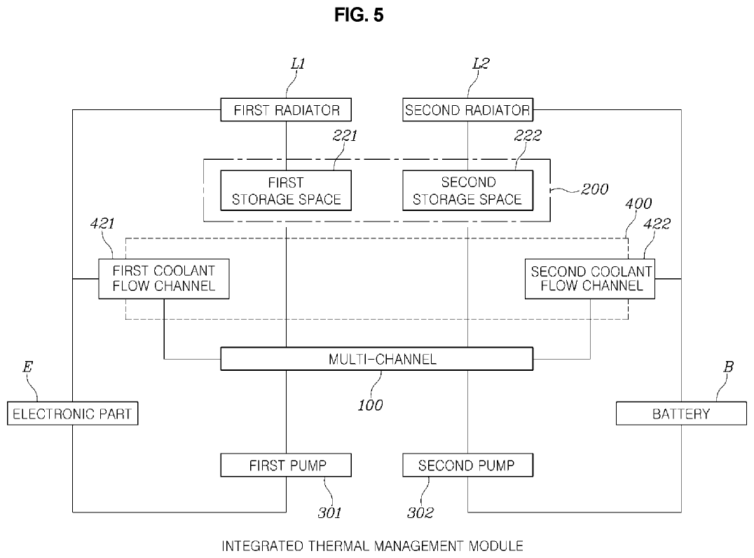

The coolant flow channel 420 and a refrigerant flow channel are disposed within the chiller 400. Referring to FIG. 4, a coolant that cools the battery B and a coolant that cools the electronic part E are not mixed because the inside of the coolant flow channel 420 is partitioned into the plurality of spaces by the barrier rib 450. Furthermore, the coolant entrance 430 is formed on the side of the chiller 400, and the coolant entrance 430 is coupled to the multi-channel 100.

The pump 300 is coupled to the multi-channel 100, and plays a role of pressurizing a coolant. The pump 300 is configured in plural number, which is identical with the number of coolant flow channel partition spaces of the reservoir 200 and the chiller 400. The pumps 300 are coupled to the multi-channel 100.

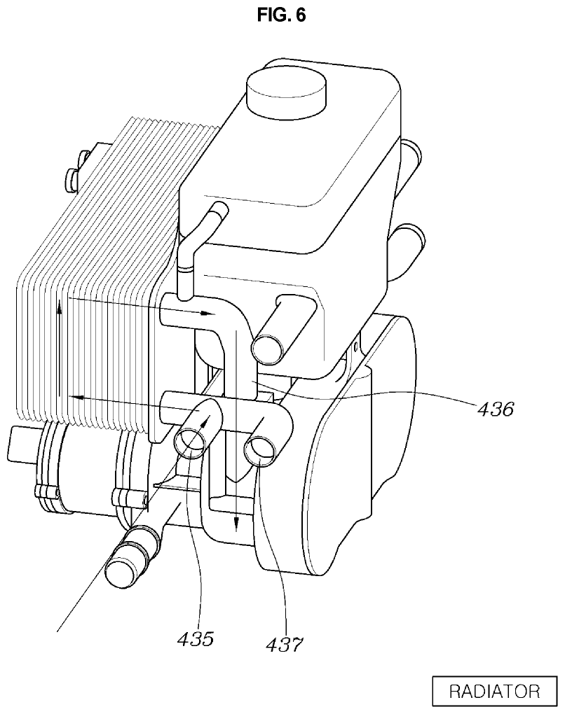

In the present embodiment, the integrated thermal management module may be internally divided into an electronic part cooling part and a battery cooling part. FIG. 5 is a circuit diagram of the integrated thermal management module according to an embodiment of the present disclosure. The electronic part cooling part constitutes a first storage space 221 of the reservoir, a first coolant flow channel 421, a first valve body 501, and a first pump 301. Accordingly, a first coolant has its flow controlled by the first valve body 501 and is pressurized by the first pump 301. The first coolant cools only the electronic part E, and is stored in the first storage space 221 of the reservoir. Furthermore, the first coolant plays a role of dissipating waste heat of the electronic part E through a first radiator L1 or recovering waste heat of the electronic part E and delivering the waste heat to a refrigerant through the first coolant flow channel 421.

Furthermore, the battery cooling part constitutes a second storage space 222 of the reservoir, a second coolant flow channel 422, a second valve body 502, and a second pump 302. Accordingly, a second coolant has its flow controlled by the second valve body 502 and is pressurized by the second pump 302. The second coolant cools only the battery B, and is stored in the second storage space 222 of the reservoir. Furthermore, the second coolant plays a role of dissipating waste heat of the battery B through a second radiator L2 or indirectly cooling the battery B through the second coolant flow channel 422.

According to the integrated thermal management module for a vehicle according to an embodiment of the present disclosure, the electronic part E and the battery B can be managed in different temperature ranges because they are cooled by separated coolants, and durability and performance of each of the electronic part E and the battery B can be maintained in an optimum state. Furthermore, there are advantages in that the size of the integrated thermal management module is very compact and a production cost is low because a flow of a plurality of coolants can be controlled by the one module.

Referring to FIG. 3, the chiller 400 includes a plurality of coolant entrances 430. The coolant entrance 430 constitutes a coolant entrance 435 and a radiator inlet 437. A coolant exit 436 may be disposed over the coolant entrance 435.

Specifically, since the first coolant and the second coolant flow through the first coolant flow channel 421 and the second coolant flow channel 422 within the chiller 400, respectively, the coolant entrances 435 for supplying the first coolant and the second coolant, respectively, are necessary. Furthermore, likewise, the coolant exits 436 for the first coolant and the second coolant are also necessary. In this case, it is preferred that the coolant exit 436 is disposed over the coolant entrance 435. In particular, a coolant cooled in a naturally inherited manner can be supplied to the multi-channel 100 through the coolant exit.

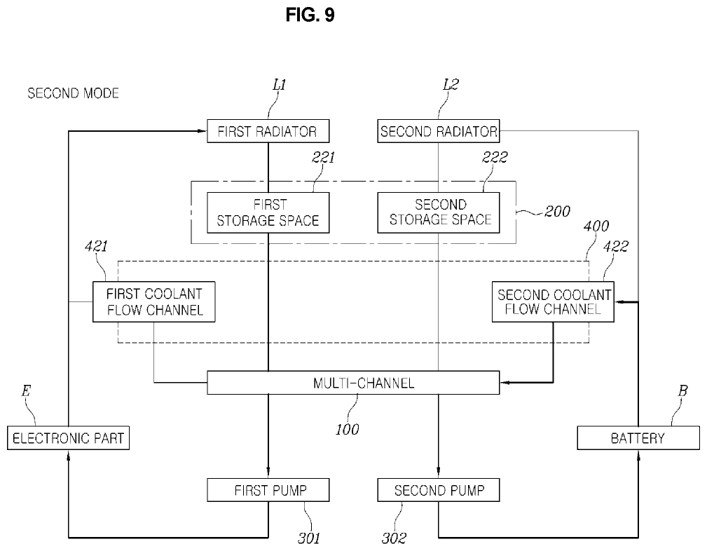

Furthermore, as will be described later, a degassing pipe 440 for the degassing of a coolant may be disposed in the coolant exit 436, and may communicate with a degassing space 260 (see FIG. 11) formed in the reservoir 200. In particular, a case where the coolant exit 436 is disposed over the coolant entrance 435 has excellent degassing efficiency.

When a coolant is cooled through the chiller 400, the coolant flows into the coolant flow channel 420 of the chiller 400 through the coolant entrance 435 of the chiller 400 and is discharged to the multi-channel 100 through the coolant exit 436. When a coolant is not cooled through the chiller 400, the coolant flows into the radiator L through the radiator inlet 437 of the coolant entrance 430. That is, since the coolant is prevented from flowing into the chiller 400 by blocking the valve space coupled to the coolant exit 436 of the chiller 400 through the rotation of the valve body 500, the coolant flown through the coolant entrance 435 may flow into the radiator inlet 437 again, so that waste heat can be dissipated through the radiator L.

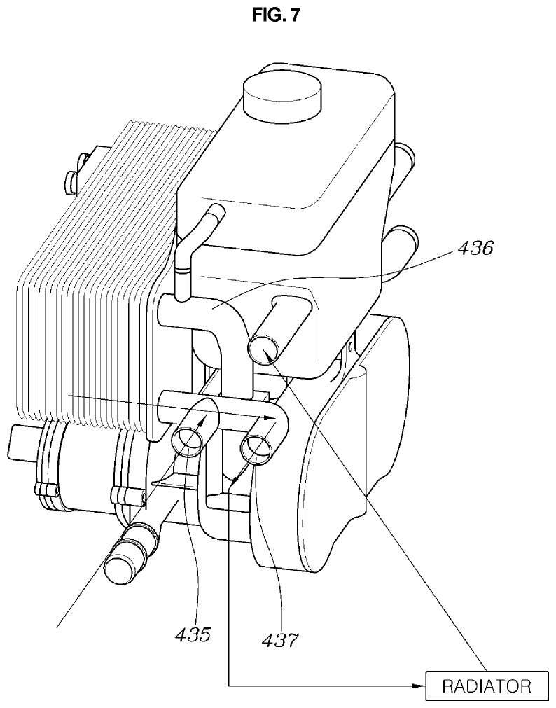

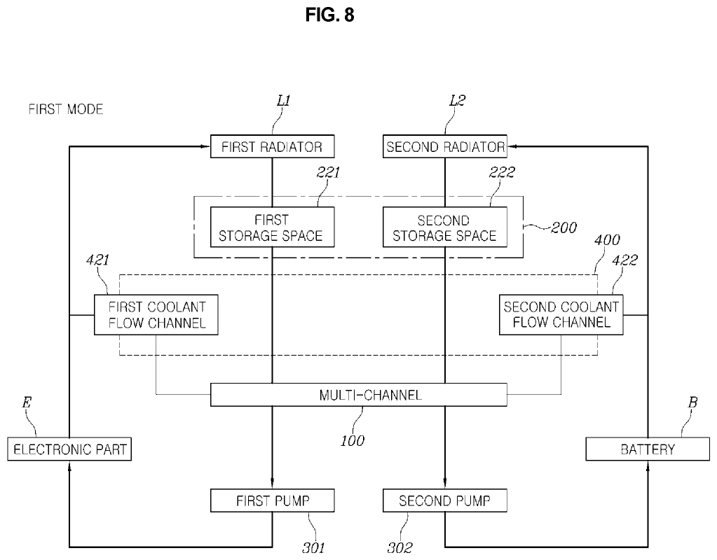

FIGS. 6 to 10 are diagrams and circuit diagrams for illustrating a flow of a coolant. A flow of a coolant is specifically described with reference to FIGS. 6 to 10. The integrated thermal management module of the present disclosure may have a first mode, a second mode, and a third mode depending on a rotation of the valve body 500. This is for managing heat of the electronic part and the battery in an optimum coolant circulation mode depending on an outdoor temperature and a driving condition of a vehicle.

First, in the first mode, a first coolant within the first storage space 221 is supplied to the first pump 301 through the first valve body 501 of the multi-channel 100 and pressurized through the first pump 301. After the first coolant cools the electronic part E, heat of the first coolant is dissipated through the first radiator L1. Thereafter, the first coolant within the first storage space 221 flows into the first valve of the multi-channel 100 and circulates. Furthermore, the second coolant also circulates in order of the second storage space 222-second valve body 502 of multi-channel-second pump 302-battery B-second radiator L2.

In the second mode, the electronic part is cooled through the first radiator L1 as in the first mode, but the battery B is cooled through the chiller 400.

Furthermore, in the third mode, both the electronic part E and the battery B are cooled through the chiller 400. In the third mode, if the driving of the second pump 302 of the battery cooling part is more delayed than the driving of the first pump 301 depending on an option and an operation of the chiller 400 is stopped, waste heat of the electronic part E may be recovered by a refrigerant, may be delivered to the second coolant, and may be used to heat the battery B.

The degassing space 260 for the degassing of a coolant is provided on the upper side of the reservoir. The degassing space 260 may be coupled to the coolant exit of the chiller.

Referring to FIG. 11, the upper side of the reservoir 200 is provided with a separate space not filled with a coolant, and is a space for degassing. In a process of a coolant flowing through the inside of a vehicle, several gases are absorbed into the coolant to form bubbles. In this case, the generated bubbles degrade cooling efficiency of the coolant, and may generate noise and damage to the pump by causing the cavitation of the pump. Accordingly, it is preferred that the degassing space 260 for discharging the bubbles of the coolant to the outside is provided.

The chiller may further include the degassing pipe 440 branched from the coolant entrance or exit of the chiller or the radiator inlet and configured to communicate with the degassing space of the reservoir.

FIG. 1 illustrates, as one embodiment, the degassing pipe 440 branched from the coolant exit 436 of the chiller and configured to communicate with the degassing space 260.

When a coolant flows through the chiller 400, the degassing pipe 440 for inducing bubbles included in the coolant to exit from the chiller 400 is separately provided in the chiller 400 because the coolant does not flow into the reservoir 200. The degassing pipe 440 communicates with the degassing space 260 of the reservoir 200, so that the degassing of the coolant flowing through the chiller 400 can be performed. In this case, the degassing pipe 440 may be branched from the coolant entrance 435 or the radiator inlet 437 in addition to the coolant exit 436, and may communicate with the degassing space 260.

If the degassing pipe 440 is branched from the coolant exit 436, there is an advantage in that degassing efficiency can be improved due to a stabilized flow of a coolant because the coolant exit 436 is formed nearest to the reservoir 200 and disposed at a high position. Furthermore, there is an advantage in that the size of the thermal management module can become compact because the length of the degassing pipe is reduced.

Accordingly, it is preferred that the degassing pipe 440 is branched from the coolant exit 436.

In contrast, if the degassing pipe 440 is branched from the coolant entrance 435 or the radiator inlet 437, the amount of bubbles flowing on a surface of a coolant may be great compared to the coolant exit 436 because the coolant having a relatively high temperature flows. However, an eddy is formed because the degassing pipe 440 is close to the pump, and degassing efficiency is poor compared to the case where the degassing pipe 440 is formed in the coolant exit 436 due to a fast flow velocity.

The multi-channel 100 and the reservoir 200 may be made of different materials.

In a conventional technology, components such as the chiller 400 and the pumps 300 are coupled around the reservoir 200. Accordingly, there are problems in that a weight of the thermal management module is increased because the reservoir 200 is inevitably made of a heavy and solid hard material like the multi-channel 100 and thus mileage of a vehicle is relatively reduced.

If components are coupled around the multi-channel 100 as an embodiment of the present disclosure, in particular, the reservoir 200 performing only the coolant storage function does not need to use the same hard material as the multi-channel 100, and a weight of the reservoir 200 can be reduced compared to the conventional technology because it is sufficient if the reservoir 200 is made of a soft material capable of withstanding a load according to coolant weight. Accordingly, mileage can be increased due to a reduced weight of the vehicle, and thus battery efficiency can be improved.

Preferably, the reservoir may be made of a softer material than the multi-channel.

A soft material has relatively lower opacity than a hard material. Accordingly, if the reservoir is made of the soft material, the visibility of the reservoir 200 is increased. This makes it easy to check a residual quantity of a coolant stored in the reservoir 200. If the coolant is lost and not sufficient, there are problems in that the durability of a part is reduced because the electronic part E and the battery B are not properly cooled, and battery efficiency is significantly reduced because the battery B greatly depends on a driving temperature, and is driven in a condition of more than an optimum temperature. Accordingly, the supplement of a coolant is very important, and the amount of a lost coolant can be easily checked and supplemented through the reservoir 200 having improved visibility.

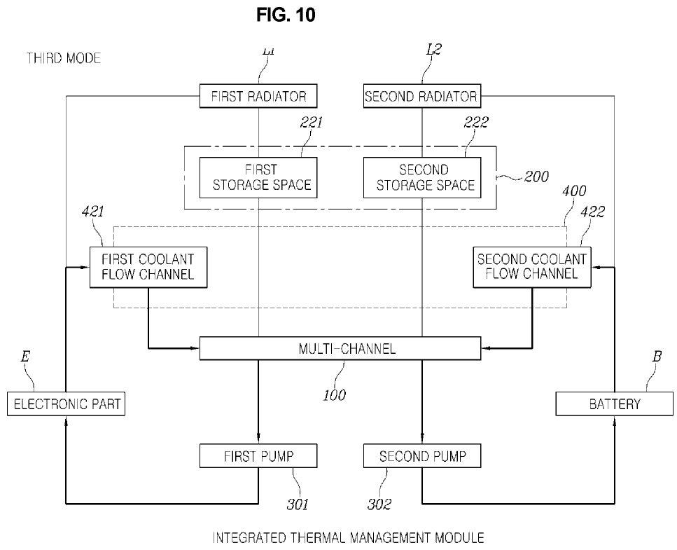

FIG. 12 illustrates the state in which the reservoir 200 and the multi-channel 100 according to an embodiment of the present disclosure are coupled. The reservoir is disposed over the multi-channel. A multi-channel coupling part 280 for coupling each coolant channel 120 of the multi-channel 100 and the reservoir 200 may be disposed at the bottom of each storage space.

The abnormality of a function according to a loss of a coolant stored in the reservoir 200 has a great influence on an operation of an electric vehicle. Accordingly, it is preferred that the coolant channel 120 of the multi-channel 100 and the multi-channel coupling part 280 are sealed as much as possible without a space from which a coolant may leak so that the coolant is maintained, and thus not lost.

Accordingly, a contact groove 290 is inward indented at the end of the multi-channel coupling part 280. The coolant channel 120 is inserted and fitted into the contact groove 290, so that the outer circumference surface and inner circumference surface of the coolant channel 120 may be surrounded and coupled to the end of the multi-channel coupling part 280.

Referring to FIG. 12, a cross section of the multi-channel coupling part 280 which is longitudinally cut has a shape, such as “n”, and the inward indented contact groove 290 comes into contact with the outer circumference surface of the coolant channel 120. Accordingly, a coolant can be prevented from being lost toward the outside of the reservoir 200 because the multi-channel coupling part 280 is configured to surround the outer circumference surface and inner circumference surface of the coolant channel 120. Furthermore, there is an advantage in that a degree that the reservoir and the multi-channel are expanded or contracted due to heat does not need to be considered because perfect sealing can be performed.

Furthermore, a friction unit M may be provided between one end of the coolant channel 120 and the contact groove 290 of the multi-channel coupling part 280. The friction unit M prevents the coolant channel 120 and the multi-channel coupling part 280 from coming into direct contact with each other, thus preventing the abrasion of the coolant channel 120 and the multi-channel coupling part 280. Accordingly, the durability of the integrated thermal management module can be increased. Furthermore, the friction unit M can also perform a sealing function by preventing a coolant from leaking into a gap where the multi-channel coupling part 280 and the coolant channel 120 are coupled due to a capillary phenomenon and a countercurrent.

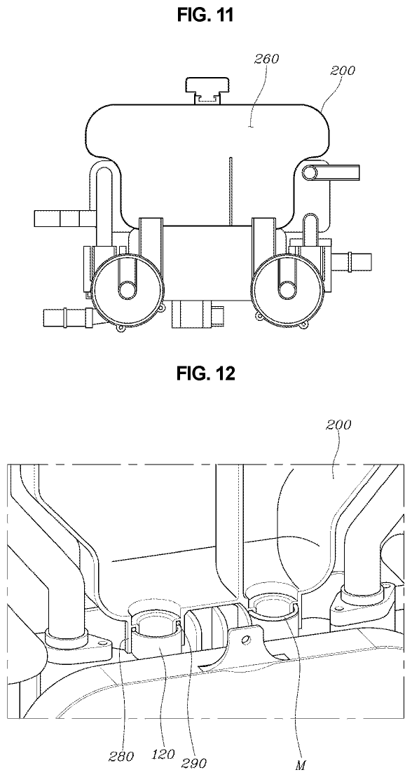

FIG. 13 illustrates the state in which the reservoir and the multi-channel according to another embodiment of the present disclosure are coupled. A sealing groove 125 to which a sealing part S is coupled is provided on one side of the outer circumference surface of the coolant channel 120 coupled to the reservoir 200. The sealing part S is coupled to the sealing groove 125. The sealing part S may be disposed between the outer circumference surface of the coolant channels 120 and the inner circumference surface of the multi-channel coupling part 280.

If the reservoir and the multi-channel are coupled as in FIG. 13, there is an advantage in that when the reservoir and the coolant channel of the multi-channel are injected, a mold is relatively simple compared to the embodiment of FIG. 13. Furthermore, there is an effect in that a loss of a coolant can be prevented because a gap between the reservoir 200 and the coolant channel 120 is sealed by the sealing part S, such as an O-ring.

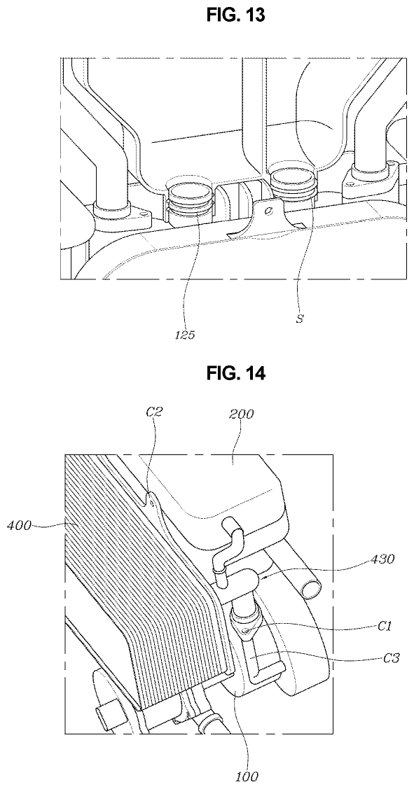

FIG. 14 illustrates the state in which the reservoir of the chiller and the multi-channel according to an embodiment of the present disclosure are coupled. A first fastening unit C1 is provided in the coolant entrance 430 of the chiller. A third fastening unit C3 is provided on one side of the multi-channel 100. The chiller 400 and the multi-channel 100 are coupled through the coupling of the first fastening unit C1 and the third fastening unit C3. A second fastening unit C2 is provided on one side of the chiller 400. A fourth fastening unit (not illustrated) is provided on the outside of the reservoir 200. Accordingly, the chiller and the reservoir may be coupled through the coupling of the second fastening unit C2 and the fourth fastening unit.

The chiller 400 may be fastened to the multi-channel 100 through the first fastening unit C1 and the third fastening unit in order to be fastened to the multi-channel 100. Furthermore, the chiller 400 may be fastened to the reservoir 200 through the second fastening unit C2 and the fourth fastening unit in order to be fastened to the reservoir 200. A method of coupling the fastening units may be performed by overlapping holes formed in the fastening units and then inserting a bolt, etc. into the holes. In general, the chiller 400 is made of an aluminum material. If the chiller 400 made of the aluminum material is fastened to the multi-channel 100 and the reservoir 200, there is an effect in that a coolant can be prevented from being lost by suppressing a portion where the reservoir 200 and the multi-channel 100 are coupled from being widened when the reservoir 200 made of a soft material is deformed by heat.

The coolant entrance 430 of the chiller 400 may be injected by being integrated and molded with the chiller 400. This is advantageous in that the number of parts necessary for the integrated thermal management module can be reduced and the integrated thermal management module can be compactly fabricated.

Referring to FIGS. 1 and 2, the integrated thermal management module for a vehicle according to an embodiment of the present disclosure for achieving the object includes the multi-channel 100 in which the valve space is formed in plural number and the plurality of coolant channels communicating with the valve spaces are disposed around the valve spaces; the reservoir 200 coupled to the multi-channel 100 and configured to have the inside partitioned into the plurality of storage spaces and to have the storage spaces coupled to the coolant channels 120 of the multi-channel; the pump 300 configured in plural number and coupled to the multi-channel 100 in a way to communicate with each of the valve spaces; and the valve body 500 configured in plural number, inserted into each of the valve spaces, and configured to open and close the coolant channels 120 around the valve spaces of the multi-channel 100 upon operation.

If components are coupled around the multi-channel 100 as in the present disclosure, in particular, the reservoir 200 performing only the coolant storage function does not need to use the same hard material as the multi-channel 100. A weight of the reservoir 200 can be reduced compared to a conventional technology because the reservoir 200 only must be made of a soft material which can withstand a load according to a coolant weight. Accordingly, mileage can be increased due to a reduced weight of a vehicle, and thus battery efficiency can be improved.

The integrated thermal management module for a vehicle may further include the chiller 400 coupled to the multi-channel and configured to have a coolant and a refrigerant thermally exchanged therein and to have the coolant flow channel therein partitioned into the plurality of spaces, wherein the space for each coolant flow channel is coupled to each valve space of the multi-channel through the coolant entrance.

The chiller may further include the degassing pipe 440 branched from the coolant entrance or exit of the chiller or the radiator inlet and configured to communicate with the degassing space of the reservoir.

The degassing space 260 for the degassing of the coolant may be provided on the upper side of the reservoir 200. The degassing space 260 may be coupled to the coolant exit 436 of the chiller 400.

The multi-channel 100 and the reservoir 200 are made of different materials. The reservoir 200 may be made of a softer material than the multi-channel 100.

According to the integrated thermal management module for a vehicle according to an embodiment of the present disclosure, a weight of the reservoir is reduced because the reservoir is made of a soft material. Accordingly, a weight of the integrated thermal management module is reduced, a production cost for the integrated thermal management module is reduced, and the visibility of the reservoir is improved. Furthermore, the durability of the pump can be increased because degassing performance of a coolant can be maximized, and heat of a battery and an electronic part can be effectively managed. In particular, the integrated thermal management module can become compact because the valve body and the pump are coupled to the multi-channel with the multi-channel interposed therebetween so that they have the same rotation axis. Accordingly, the integrated thermal management module has the most effective layout advantageous for even a molding structure.

While the specific exemplary embodiment of the present disclosure has been illustrated and described, it will be apparent to those skilled in the art that the present disclosure may be variously improved and changed without departing from the technical spirit of the present disclosure provided by the appended claims.

What is claimed is:

1. An integrated thermal management module for a vehicle, the integrated thermal management module comprising:
a multi-channel including a plurality of valve spaces, and a plurality of coolant channels communicating with the valve spaces and disposed around the valve spaces;
a plurality of valve bodies inserted into the valve spaces, respectively, the valve bodies configured to open and close the coolant channels around the valve spaces of the multi-channel upon operation; and
a plurality of pumps coupled to the multi-channel,
wherein the valve spaces are formed on one side of the multi-channel, the valve bodies are coupled to the one side of the multi-channel, the pumps are coupled to an opposite side of the multi-channel, and a rotation axis of each the valve bodies and a rotation axis of each of the pumps are identical.

2. The integrated thermal management module according to claim 1, further comprising:
a reservoir coupled to the multi-channel and configured to have an inside partitioned into a plurality of storage spaces and to have the storage spaces coupled to the coolant channels of the multi-channel; and
a chiller coupled to the multi-channel and configured to have a coolant and a refrigerant thermally exchanged therein and to have a coolant flow channel therein partitioned into a plurality of spaces, wherein the space for each coolant flow channel is coupled to each of the valve spaces of the multi-channel through a coolant entrance.

3. The integrated thermal management module according to claim 2, wherein:
a degassing space for degassing of the coolant is provided on an upper side of the reservoir, and
the degassing space is coupled to a coolant exit of the chiller.

4. The integrated thermal management module according to claim 2, wherein the chiller further comprises a degassing pipe branched from a coolant entrance or exit of the chiller or a radiator inlet and configured to communicate with a degassing space of the reservoir.

5. The integrated thermal management module according to claim 2, wherein:
the multi-channel and the reservoir are made of different materials, and
the reservoir is made of a softer material than the multi-channel.

6. The integrated thermal management module according to claim 2, wherein:
the reservoir is disposed over the multi-channel, and
a multi-channel coupling part for coupling the coolant channel of the multi-channel and the reservoir is disposed at a bottom of each of the storage spaces.

7. The integrated thermal management module according to claim 6, wherein:
a contact groove is inward indented and formed at an end of the multi-channel coupling part, and
the coolant channel is inserted and fitted into the contact groove so that an outer circumference surface and inner circumference surface of the coolant channel are surrounded and coupled to an end of the multi-channel coupling part.

8. The integrated thermal management module according to claim 7, wherein a friction unit is provided in the contact groove of the multi-channel coupling part into which the coolant channel is inserted.

9. The integrated thermal management module according to claim 2, wherein:
a first fastening unit is provided at the coolant entrance of the chiller, a third fastening unit is provided on the one side of the multi-channel, and the chiller and the multi-channel are coupled through coupling of the first fastening unit and the third fastening unit, and
a second fastening unit is provided on one side of the chiller, a fourth fastening unit is provided on an outside of the reservoir, and the chiller and the reservoir are coupled through coupling of the second fastening unit and the fourth fastening unit.

10. The integrated thermal management module according to claim 2, wherein the coolant entrance of the chiller is integrated and molded with the chiller.

11. An integrated thermal management module for a vehicle, the integrated thermal management module comprising:
a multi-channel including a plurality of valve spaces, and a plurality of coolant channels communicating with the valve spaces and disposed around the valve spaces;
a reservoir coupled to the multi-channel and configured to have an inside partitioned into a plurality of storage spaces and to have the storage spaces coupled to the coolant channels of the multi-channel;
a plurality of pumps coupled to the multi-channel in a way to communicate with the valve spaces, respectively; and
a plurality of valve bodies, inserted into the valve spaces, respectively, and configured to open and close the coolant channels around the valve spaces of the multi-channel upon operation.

12. The integrated thermal management module according to claim 11, further comprising a chiller coupled to the multi-channel and configured to have a coolant and a refrigerant thermally exchanged therein and to have a coolant flow channel therein partitioned into a plurality of spaces, wherein the space for each coolant flow channel is coupled to each valve space of the multi-channel through a coolant entrance.

13. The integrated thermal management module according to claim 12, wherein the chiller further comprises a degassing pipe branched from a coolant entrance or exit of the chiller or a radiator inlet and configured to communicate with a degassing space of the reservoir.

14. The integrated thermal management module according to claim 11, wherein:
a degassing space for degassing of a coolant is provided on an upper side of the reservoir, and
the degassing space is coupled to a coolant exit of the chiller.

15. The integrated thermal management module according to claim 11, wherein:
the multi-channel and the reservoir are made of different materials, and
the reservoir is made of a softer material than the multi-channel.
